(19) United States
(12) Patent Application Publication
(10) Pub. No.: US 2026/0016235 A1
(43) Pub. Date: Jan. 15, 2026

(54) HEAT PIPE FOR SMALL MODULAR REACTOR, AND NUCLEAR POWER GENERATING SYSTEM COMPRISING SAME

(71) Applicant: Dunedin Energy Systems Limited, Oro-Medonte (CA)

(72) Inventors: Peter Lang, Oro-Medonte (CA); Robert Harvey, Oro-Medonte (CA); Adriaan Buijs, Oro-Medonte (CA)

(21) Appl. No.: 18/974,111

(22) Filed: Dec. 9, 2024

Related U.S. Application Data
(60) Provisional application No. 63/610,834, filed on Dec. 15, 2023.

(51) Int. Cl. F28D 15/02; F28D 21/00; F28F 21/08

(52) U.S. Cl. CPC F28D 15/0275; F28F 21/083; F28D 2021/0054

(57) ABSTRACT

A heat pipe for a small modular reactor includes: an evaporator portion fabricated of a first material; and a condenser portion fabricated of a second material, the evaporator portion and the condenser portion being joined to define an interior containing a working fluid. The first material has a lower neutron capture cross section than the second material. The second material has a higher oxidation resistance above 150° C. than the first material.

### CROSS-REFERENCE TO RELATED APPLICATION

This application claims the benefit of U.S. Provisional Application No. 63/610,834 filed Dec. 15, 2023, the content of which is incorporated herein by reference in its entirety.

### FIELD

The subject disclosure relates generally to nuclear power and in particular, to a heat pipe for a small modular reactor, and a nuclear power generating system comprising the same.

### BACKGROUND

In the field of electrical power generation, nuclear power plays a significant role. In Canada, nuclear power accounts for 15% of all electrical power generated, while in the United States, nuclear power accounts for 19% of all electrical power generated. The vast majority of this nuclear power is generated using thermal neutron spectrum reactors, which use water as a neutron moderator and as a primary heat transport medium.

An emerging category of nuclear reactor is the small modular reactor (SMR), which is generally defined as having a power output of 300 megawatts electric (MWe) or less. Within SMRs, there exists a category of smaller reactors known as micro-reactors (MRs), which are defined as having a power output of about 15 MWe or less. Some SMRs and MRs use solid materials, such as graphite, as a neutron moderator. These reactors are generally referred to as “solid-state” nuclear reactors, due to their solid reactor core. Solid-state nuclear reactors are generally compact and have a relatively simple construction.

The method of removing generated heat from the reactor core is a key design feature of any nuclear reactor. Heat pipes, sometimes referred to as “thermosyphons”, are a primary heat transport technology that is well-suited to solid-state nuclear reactors. Heat pipes are elongate, partially evacuated sealed tubes containing a fixed charge of a heat exchange medium that undergoes reversible phase changes along the interior length of the heat pipe, in accordance with the surrounding temperature.

Solid state reactors with heat pipes have been described. For example, the non-patent publication entitled “The Nuclear Battery: a Solid-State, Passively cooled Reactor for the Generation of Electricity and/or High-Grade Steam Heat” (AECL-9570) authored by K. S. Kozier and H. E. Rosinger and published by Atomic Energy of Canada Limited (1988), describes development of a small, solid-state, passively cooled reactor power supply known as the Nuclear Battery. Key technical features of the Nuclear Battery reactor core include a heat-pipe primary heat transport system, graphite neutron moderator, low-enriched uranium tristructural-isotropic (TRISO) coated-particle fuel and the use of burnable poisons for long-term reactivity control. An external secondary heat transport system extracts heat energy from the upper portions of the heat pipes, which may be converted into electricity in a Rankine cycle turbogenerator or used to produce high-pressure steam. The design is capable of producing about 2400 kWt (about 600 kWe) for 15 full-power years.

Improvements are generally desired. It is an object at least to provide a novel heat pipe for a small modular reactor and a nuclear power generating system comprising the same.

### SUMMARY OF THE INVENTION

Accordingly, in one aspect there is provided a heat pipe for a small modular reactor, the heat pipe comprising: an evaporator portion fabricated of a first material; and a condenser portion fabricated of a second material, the evaporator portion and the condenser portion being joined to define an interior containing a working fluid, the first material having a lower neutron capture cross section than the second material, the second material having a higher oxidation resistance above 150° C. than the first material.

The first material may be zirconium or a zirconium alloy.

The second material may be stainless steel, or may be a non-ferrous material.

The heat pipe may further comprise: a flange configured to abut an outer surface of a reactor vessel enclosing the small modular reactor. The flange may be configured to couple the heat pipe to the reactor vessel.

The condenser portion may have a vaporizer coupled thereto, the vaporizer defining a conduit for conveying a heat exchange fluid. The vaporizer and the condenser portion may be integrally formed. The vaporizer and the condenser portion may define a single, unitary piece.

The evaporator portion and the condenser portion may be connected by a joint. The joint may comprise one or more of: fasteners, at least one weld, and at least one bond. Alternatively, the joint may comprise one or more of: a threaded portion; a ring seal portion; and a thermally-enhanced interference fit portion. The joint may comprise the threaded portion, the ring seal portion; and the thermally-enhanced interference fit portion.

In one embodiment, there is provided a small modular reactor comprising at least one heat pipe as described above.

In one embodiment, there is provided a nuclear power generating system comprising the small modular reactor as described above.

### BRIEF DESCRIPTION OF THE DRAWINGS

Embodiments will now be described more fully with reference to the accompanying drawings in which:

FIG. 1 is a schematic view of a nuclear power generating system;

FIG. 2 is a perspective, sectional view of a small modular reactor forming part of the nuclear power generating system of FIG. 1;

FIG. 3 is a perspective, cutaway view of a heat pipe forming part of the small modular reactor of FIG. 2; and

FIGS. 4 to 6 are sectional, enlarged fragmentary views of a portion of the heat pipe of FIG. 3.

### DETAILED DESCRIPTION OF THE EMBODIMENTS

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

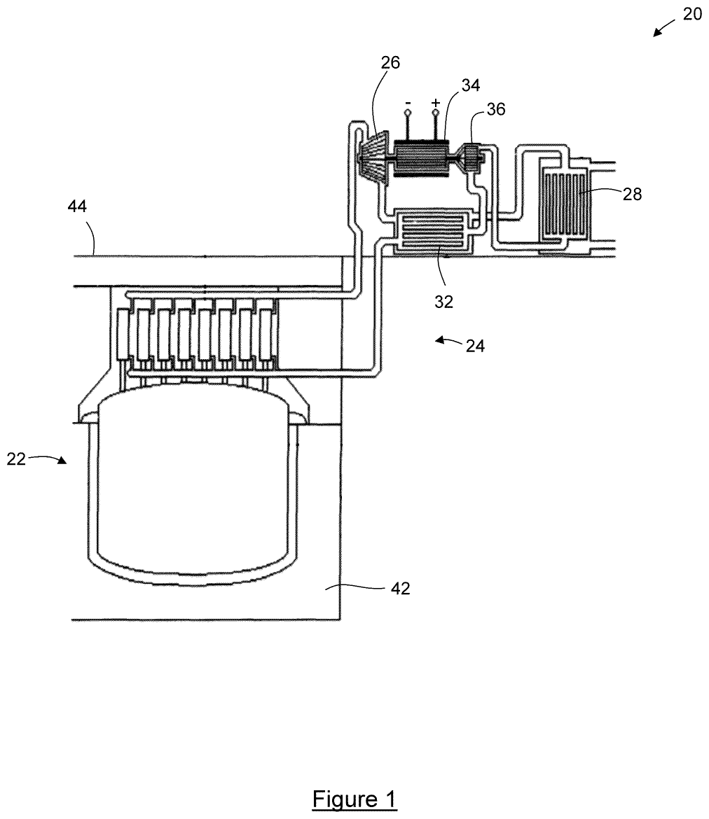

Turning now to FIG. 1, a nuclear power generating system is shown and is generally indicated by reference numeral 20. System 20 comprises a nuclear reactor in the form of a small modular reactor (SMR). The system 20 is configured to sustain nuclear fission for generating electricity, more broadly referred to as generating nuclear power. In particular, the system 20 comprises a small modular reactor 22 and a closed, secondary cooling circuit 24 that is in thermal communication with a heat exchange portion outside of, and above, the reactor 22. The secondary cooling circuit 24 has a heat exchange fluid flowing directionally therethrough. In the example shown, the heat exchange fluid is toluene, however it will be understood that other suitable organic or inorganic heat exchange fluids may alternatively be used. The secondary cooling circuit 24 is in fluidic communication with a turbine 26 positioned downstream of the reactor 22, a condenser 28 positioned downstream of the turbine 26, and a regenerator 32 positioned downstream of the condenser 28. The turbine 26 is coupled to an alternator 34 and a pump 36. As will be understood, the system 20 is configured to generate electricity using heat generated by the reactor 22 through i) vaporization of the heat exchange fluid to generate vaporized heat exchange fluid, which ii) rotates the turbine 26 and hence the alternator 34, and iii) is subsequently condensed by the condenser 28 and returned to the heat exchange portion of the reactor 22, thereby completing an organic Rankine cycle.

An underside of the reactor 22 is surrounded by a shield 42 that is configured to contain thermal leakage, as well as any radioactive leakage, from the reactor 22. The shield 42 may be fabricated of concrete, for example. In the example shown, the reactor 22 and the shield 42 are shown as being positioned below grade 44, however it will be understood that the reactor 22 and the shield 42 may alternatively be positioned differently relative to grade.

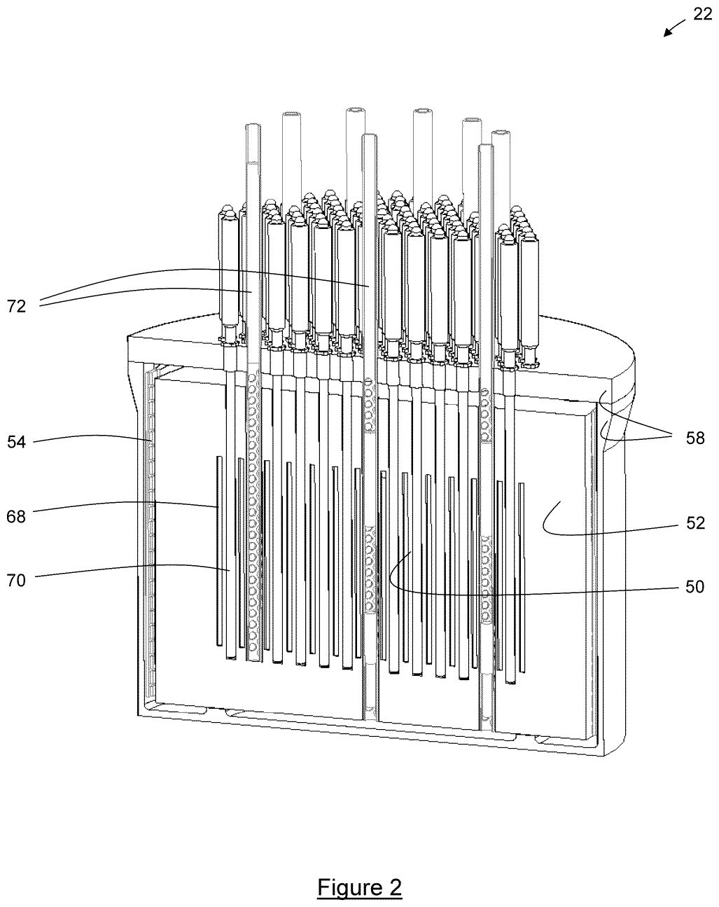

The reactor 22 may be better seen in FIG. 2. In the example shown, the reactor 22 is a small modular reactor (SMR) and is of smaller size than conventional, light water- or heavy water-cooled nuclear reactors. The reactor 22 comprises a reactor core 50 fabricated of solid graphite, and as a result the reactor 22 may be termed a “solid-state” nuclear reactor. The core 50 is surrounded by a neutron reflector layer 52, which is configured to reduce transmission or “leakage” of neutrons from the core 50. In the example shown, the neutron reflector layer 52 is graphite. A thermal insulation layer 54 surrounds the sides of the neutron reflector layer 52. The core 50, neutron reflector layer 52 and thermal insulation layer 54 are, in turn, housed within a generally cylindrical reactor vessel 58. In the example shown, the reactor vessel 58 is fabricated of stainless steel, such as austenitic stainless steel, and has an inner diameter of about 3.9 m and an inner height of about 2.8 m, however it will be understood that the reactor vessel 58 may alternatively be differently sized. The reactor vessel 58 is generally fluidically sealed from its surroundings, and contains an inert atmosphere containing one or more inert gases, such as helium, argon and the like. As will be understood, the inert atmosphere contained in the reactor vessel 58 prevents oxidation of the contents of the core 50 at the significantly high operational temperatures (namely, 600° C. or higher) experienced in the core 50 during operation.

The core 50 has a spaced arrangement of bores formed therein for accommodating fuel rods 68, heat pipes 70 and moveable control rods 72. The fuel rods 68 and the heat pipes 70 are static, while the control rods 72 are configured to be individually moved into and out of the core 50 during operation for controlling the heat output of the reactor 22. The control rods 72 may be, for example, one or more of the control rods described in U.S. Application Ser. No. 63/695,070 filed Sep. 16, 2024 and titled “CONTROL ROD APPARATUS FOR SMALL MODULAR REACTOR, AND SMALL MODULAR REACTOR COMPRISING SAME”, the content of which is incorporated herein by reference in its entirety.

Each fuel rod 68 comprises a plurality of generally cylindrical fuel compacts (not shown) that are stacked in an end-to-end manner within a respective bore formed in the core 50. The fuel compacts each comprise a plurality of spherical fuel kernels (not shown) of low-enriched uranium dioxide (UO₂) having a diameter of about 0.5 mm. Each fuel kernel is sealed in successive layers of carbonaceous materials (not shown), namely a layer of low-density buffer graphite, a first layer of high-density pyrolytic carbon, a layer of silicon carbide (SiC), and a second layer of high-density pyrolytic carbon, to form a coated kernel (not shown) having a diameter of about 0.9 mm. The coated kernels are in turn mixed with a graphite matrix binder (not shown) and formed into the solid, generally cylindrical fuel compact.

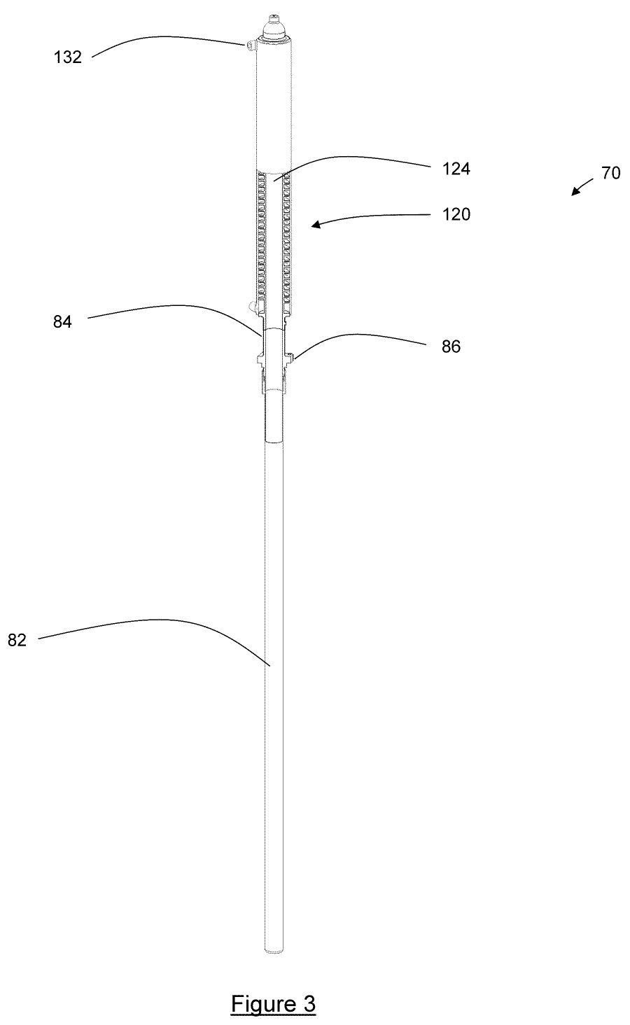

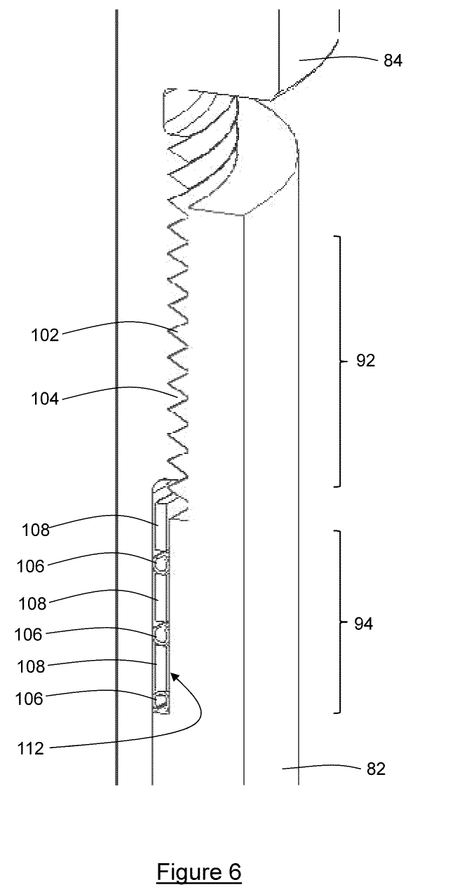

The heat pipe 70 may be better seen in FIGS. 3 to 6. Each heat pipe 70 is a sealed metallic tube that contains a quantity or “charge” of alkali metal that serves as a working fluid (not shown) during operation. The pressure of the working fluid within the heat pipe 70 is sub-atmospheric. In this embodiment, the working fluid is sodium, however in other embodiments the working fluid may alternatively be potassium.

Each heat pipe 70 extends from the bottom of core 50 to above the reactor vessel 58, as shown in FIG. 2. In particular, each heat pipe 70 comprises an evaporator portion 82 positioned inside the reactor vessel 58, a condenser portion 84 positioned outside the reactor vessel 58, and a flange 86 configured to sealingly abut an upper surface of the reactor vessel 58 to support the heat pipe 70 in a suspended position. In this manner, the heat pipe 70 is coupled to the reactor vessel 58 by the flange 86. In the example shown, the heat pipe 70 has a length of about 300 cm and an internal diameter of about 6.0 cm, however it will be understood that in other examples the heat pipe 70 may alternatively be differently sized.

The interior of each heat pipe 70 comprises a cylindrical wick 88 that extends at least a portion of the interior length of the evaporator portion 82 and at least a portion of the interior length of the condenser portion 84. The wick 88 has a porous or perforated structure and, in the example shown, the wick 88 is a layer of fine, porous material having fine granularity formed on the entireties of the interior surfaces of the evaporator portion 82 and the condenser portion 84. The fine, porous material may be, for example, a layer or coating of sintered metallic powder. Owing to the fine granularity, the surface of the wick 88 appears smooth in FIGS. 3 to 6. As will be understood, the porous or perforated configuration of the wick 88 provides a surface, and hence a flow path, along which liquid working fluid may readily flow by wicking. As the wick 88 is porous or perforated, the vaporized working fluid and the wicked liquid working fluid are able to contact each other.

The evaporator portion 82 of the heat pipe 70 is fabricated of a first material and the condenser portion 84 is fabricated of a second material. The first material has a lower neutron capture cross section than the second material, and the second material has a greater oxidation resistance above 150° C. in oxygen-rich environments, such as atmospheric air, than the first material. In the example shown, the evaporator portion 82 is fabricated of zirconium or a zirconium alloy, such as for example ASTM B353 UNS R60804, and the condenser portion 84 is fabricated of a stainless steel.

As will be understood, according to general nuclear fission theory, for a given quantity of fuel in the reactor 22, the rate of heat energy production is governed by the number of free neutrons in the core 50. Any non-fuel materials present in the core 50 that absorb free neutrons will reduce the rate of nuclear fission, and hence will reduce the rate of heat energy production. Absorption of free neutrons by non-fuel materials, which is sometimes referred to as “parasitic neutron capture”, can be reduced by using materials that have a low neutron capture cross section, a materials property that has a unit of measure of “barn”. Using materials that have a low neutron capture cross section in the core 50 advantageously avoids having to otherwise increase the quantity of fuel to achieve a desired heat energy production rate, which would otherwise increase the operating cost of the reactor 22. Fabricating the evaporator portion 82 of a material having a low neutron capture cross section advantageously results in greater operational efficiency of the core 50, and advantageously extends the service life of the quantity of fuel.

As will also be understood, to maximize the removal of heat from the reactor 22, it is desired that the condenser portion 84, which is positioned above the reactor vessel 58, be fabricated of a material having a high resistance to oxidation at elevated temperatures. During normal operation, temperatures above the reactor vessel 58 are lower than those within the core 50 (namely, 600° C. or higher) but still significantly higher than 150° C., which is an oxidation threshold of zirconium and zirconium alloys. At temperatures above 150° C., the oxidation potential of zirconium and zirconium alloys increases significantly; in other words, at temperatures above 150° C., the oxidation resistance of zirconium and zirconium alloys decreases significantly. As will be understood, because the condenser portion 84 protrudes above the reactor vessel 58, it is positioned in a conventional, oxidizing atmosphere (namely, atmospheric air) and also experiences elevated temperatures during operation. By using a material that has a high resistance to oxidation at elevated temperatures, oxidation of the condenser portion 84 during operation can advantageously be reduced or eliminated.

In the example shown, the condenser portion 84 comprises a plurality of generally cylindrical, axially aligned segments fabricated of the second material and joined by a suitable method, such as for example welding. When joined in this manner, the segments provide the condenser portion 84 having an effectively unitary structure configured to provide a sealed interior when connected to the evaporator portion 82.

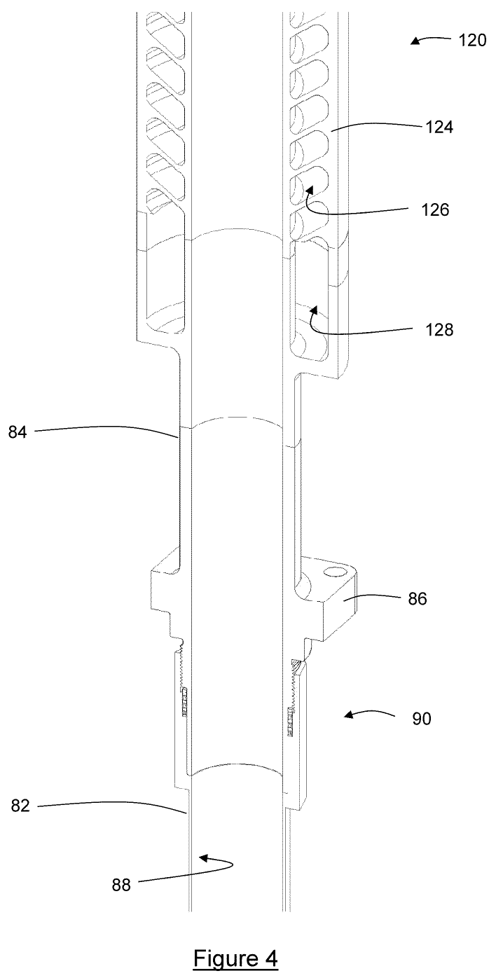

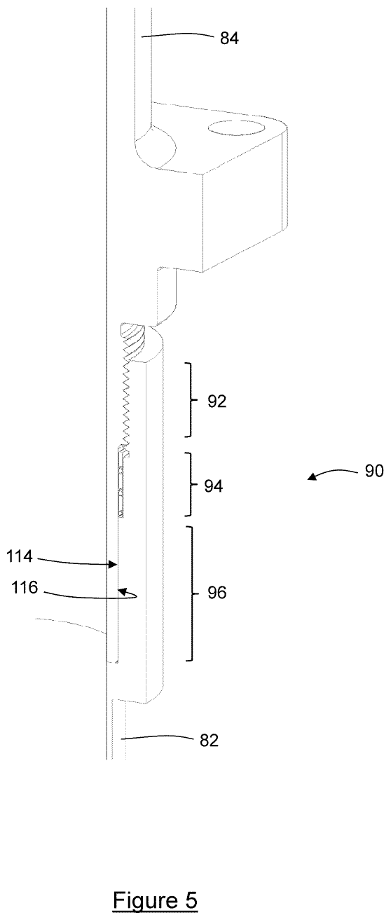

The evaporator portion 82 and the condenser portion 84 are connected by a joint 90, which may be better seen in FIGS. 4 and 5. In the example shown, the joint 90 comprises three portions, namely a threaded portion 92, a ring seal portion 94, and a thermally-enhanced interference fit portion 96. The threaded portion 92 is defined by threads 102 formed on a surface of the evaporator portion 82 and threads 104 formed on a surface of the condenser portion 84, which matingly engage to provide a seal. The ring seal portion 94 comprises one or more flexible sealing rings accommodated within an annular cavity defined between the evaporator portion 82 and the condenser portion 84. In the example shown, the ring seal portion has three (3) flexible C-rings 106 separated by spacers 108 and disposed in an annular cavity 112. The flexible C-rings 106 seal the joint 90 at ambient temperature. The thermally-enhanced interference fit portion 96 comprises two opposing cylindrical surfaces having approximately the same diameter that provide a locational fit having a small clearance at ambient temperature to allow assembly. In the example shown, the thermally-enhanced interference fit portion 96 comprises a first cylindrical sealing surface 114 formed on the evaporator portion 82, and a second cylindrical sealing surface 116 formed on the condenser portion 84. As will be understood, the evaporator portion 82 has a lower coefficient of thermal expansion than the condenser portion 84. Therefore, as the temperature increases from ambient temperature to the elevated temperatures experienced during normal operation, the male portion (namely, the second cylindrical sealing surface 116) of the thermally-enhanced interference fit portion 96 grows more than its female counterpart (namely, the first cylindrical sealing surface 114) both radially and axially and an interference fit develops in this portion of joint 90, thereby providing an improved seal at the elevated temperatures.

The condenser portion 84 has a vaporizer 120 disposed thereon for facilitating heat transfer from the heat pipe 70 to the heat exchange fluid flowing through the secondary cooling circuit 24. The vaporizer 120 comprises a hollow body 124 that defines a helical, internal passage 126. The internal passage 126 is in fluidic communication with the secondary cooling circuit 24 via an input port (not shown) defining an input passage 128 and an output port 132. As will be understood, the internal passage 126 is configured to provide a conduit through which the incoming heat exchange fluid can flow to absorb heat from the working fluid, become vaporized upon absorption of a sufficient amount of heat, and subsequently reenter the secondary cooling circuit 24 as outgoing heated vapor, thereby enabling heat exchange between the reactor 22 and the secondary cooling circuit 24.

In the example shown, the vaporizer 120 is integrally formed with a segment of the condenser portion 84 by a suitable fabrication method, such as for example by additive manufacturing (sometimes referred to as “3D printing”), casting, or machining, or by a combination of methods, such that the segment of the condenser portion 84 including the vaporizer 120 is formed as a single, unitary piece. The vaporizer 120 is fabricated of the second material, and in the example shown the vaporizer 120 is fabricated of a stainless steel. As will be appreciated, by integrally forming the vaporizer 120 with the segment of the condenser portion 84, heat transfer to the heat exchange fluid flowing through the internal passage 126 is advantageously greater than would otherwise be possible if the vaporizer were separately formed and spaced from the condenser portion 84 by, for example, an assembly clearance gap that would otherwise act as a thermal insulator.

Similar to the vaporizer 120, in the example shown, the flange 86 is also integrally formed with a segment of the condenser portion 84 by a suitable fabrication method, such as for example by additive manufacturing or by conventional machining, such the segment of the condenser portion 84 including the flange 86 is formed as a single, unitary piece The flange 86 is fabricated of the second material, and in the example shown the flange 86 is fabricated of a stainless steel.

Turning again to FIG. 2, each control rod 72 is moveable generally into and out of the core 50, and is configured to absorb (namely, parasitically capture) free neutrons to controllably reduce the rate of heat energy production in the core 50, and hence control the heat output of the reactor 22. Each control rod 72 is coupled to a respective control rod drive mechanism (not shown) positioned above the reactor 22. The control rod drive mechanisms may be in communication with, for example, processing structure (not shown) running a process control application program for generally controlling operation of the system 20.

In use, the system 20 is operated by sustaining continuous nuclear fission in the core 50 of the reactor 22. Specifically, heat energy generated by fission occurring in the fuel rods 68 travels through the core 50 to the heat pipes 70. In each heat pipe, heat energy is conducted through the wall of the evaporator portion 82, and vaporizes the working fluid in the interior of the heat pipe 70. The vaporized working fluid flows upward through the heat pipe 70 into the condenser portion 84. The heat energy from the vaporized working fluid is then conducted through the wall of each condenser portion 84 into the surrounding vaporizer 120. Inside the heat pipes 70, the loss of heat energy from the working fluid causes condensation of the working fluid, and the liquid working fluid flows downward by gravity along the surface of and through the porous structure of the wick 88 into the evaporator portion 82. The heat energy absorbed by the vaporizer 120 heats the heat exchange fluid flowing through the internal passage 126. The heated heat exchange fluid then exits the vaporizer 120 and flows through the secondary cooling circuit 24 to the turbine 26, where it rotates the turbine 26 which in turn rotates the alternator 34 to generate electricity. Downstream from the turbine 26, the heat exchange fluid passes through the regenerator 32 and the condenser 28, where it is cooled and returned to the vaporizers 120 of the heat pipes 70 to collect more heat energy originating in the core 50, and thereby sustain the generation of electrical power.

In other embodiments, the heat pipe may be differently configured. For example, although in the embodiment described above, the condenser portion 84 comprises a plurality of generally cylindrical, axially aligned segments fabricated of the second material and joined by a suitable method, such as for example welding, in other embodiments, the condenser portion may alternatively be formed as a single, unitary piece of the second material without joints.

Although in the embodiment described above, the vaporizer 120 is integrally formed with the condenser portion 84 such that the condenser portion 84 and the vaporizer 120 are formed as a single, unitary piece, in other embodiments, the hollow body defining the helical, internal passage may alternatively be formed separately and then joined to the condenser portion by a suitable method, such as for example welding. In one such embodiment, the welding may be roller welding.

Similarly, although in the embodiment described above, the flange 86 is integrally formed with the condenser portion 84 such that the condenser portion 84 and the flange 86 are formed as a single, unitary piece, in other embodiments, the flange may alternatively be formed separately and then joined to the condenser portion by a suitable method, such as for example welding, crimping, and the like.

Although in the embodiment described above, the wick 88 is a layer of fine, porous material having fine granularity formed on the entireties of the interior surfaces of the evaporator portion 82 and the condenser portion 84, in other embodiments, the porous material may alternatively be formed on only a portion of the interior surface of the evaporator portion, and/or formed on only a portion of the interior surface of the condenser portion.

Although in the embodiment described above, the wick 88 is a layer of fine, porous material having fine granularity formed on the entireties of the interior surfaces of the evaporator portion 82 and the condenser portion 84, in other embodiments, the wick may alternatively be a layer of perforated material, such as a cylindrical sleeve of wire mesh or longitudinally-oriented strips of wire mesh, disposed on or formed on interior surfaces of the evaporator portion 82 and the condenser portion 84.

Although in the embodiment described above, the evaporator portion 82 and the condenser portion 84 are connected by a joint 90 comprising the threaded portion 92, the ring seal portion 94, and the thermally-enhanced interference fit portion 96, in other embodiments, the joint may be differently configured. For example, in one such embodiment, the joint may alternatively comprise only one (1) or two (2) of the threaded portion, the ring seal portion, and the thermally-enhanced interference fit portion. In other embodiments, the joint may alternatively comprise one or more fasteners, one or more welds, and one or more bonds, either alone or in combination with each other, or in combination with any of the threaded portion, the ring seal portion, and the thermally-enhanced interference fit portion.

Although in the embodiment described above, the evaporator portion 82 is fabricated of zirconium or a zirconium alloy, such as for example ASTM B353 UNS R60804, in other embodiments, the evaporator portion may alternatively be fabricated of a different zirconium alloy, such as for example ASTM B353 UNS R60802, or may alternatively be fabricated of one or more other suitable materials having sufficiently low neutron capture cross section.

Although in the embodiment described above, the condenser portion 84 is fabricated of a stainless steel, it will be understood that in other embodiments, the condenser portion may alternatively be fabricated of one or more other suitable materials having sufficiently high oxidation resistance at the elevated temperatures. In one such embodiment, the condenser portion may be fabricated of a non-ferrous material having sufficiently high oxidation resistance at the elevated temperatures.

Although embodiments have been described above with reference to the accompanying drawings, those of skill in the art will appreciate that variations and modifications may be made without departing from the scope thereof as defined by the appended claims.

What is claimed is:

1. A heat pipe for a small modular reactor, the heat pipe comprising:
an evaporator portion fabricated of a first material; and
a condenser portion fabricated of a second material, the evaporator portion and the condenser portion being joined to define an interior containing a working fluid,
the first material having a lower neutron capture cross section than the second material, the second material having a higher oxidation resistance above 150° C. than the first material.

2. The heat pipe of claim 1, wherein the first material is zirconium or a zirconium alloy.

3. The heat pipe of claim 1, wherein the second material is stainless steel.

4. The heat pipe of claim 1, wherein the second material is a non-ferrous material.

5. The heat pipe of claim 1, further comprising:
a flange configured to abut an outer surface of a reactor vessel enclosing the small modular reactor.

6. The heat pipe of claim 5, wherein the flange is configured to couple the heat pipe to the reactor vessel.

7. The heat pipe of claim 1, wherein the condenser portion has a vaporizer coupled thereto, the vaporizer defining a conduit for conveying a heat exchange fluid.

8. The heat pipe of claim 7, wherein the vaporizer and the condenser portion are integrally formed.

9. The heat pipe of claim 7, wherein the vaporizer and the condenser portion define a single, unitary piece.

10. The heat pipe of claim 1, wherein the evaporator portion and the condenser portion are connected by a joint.

11. The heat pipe of claim 10, wherein the joint comprises one or more of:
a threaded portion;
a ring seal portion; and
a thermally-enhanced interference fit portion.

12. The heat pipe of claim 11, wherein the joint comprises the threaded portion, the ring seal portion; and the thermally-enhanced interference fit portion.

13. The heat pipe of claim 10, wherein the joint comprises one or more of: fasteners, at least one weld, and at least one bond.

14. A small modular reactor comprising at least one heat pipe of claim 1.

15. A nuclear power generating system comprising the small modular reactor of claim 14.
